(19) United States
(12) Patent Application Publication
(10) Pub. No.: US 2011/0093399 A1
(43) Pub. Date: Apr. 21, 2011

(54) Saloot's online enhanced reciprocation service

(76) Inventor: Ray Morgan Elam IV, Newport Beach, CA (US)

(21) Appl. No.: 12/582,533

(22) Filed: Oct. 20, 2009

(51) Int. Cl. G06Q 20/00; G06Q 10/00; G06Q 40/00; H04L 9/32; G06F 3/048

(52) U.S. Cl. 705/75; 705/30; 705/44; 715/760; 715/839; 715/808

(57) ABSTRACT

Saloot at its core is a money transferring service designed specifically around online voluntary micro payments, aka donations, tips, and other forms of reciprocation. It allows a web browser give amounts as small as a penny towards content they appreciate. Inherent to a voluntary payment is a power by the giver to choose when to give. Saloot.com utilizes this fact to tally these tips rather than attempt transactions at the time of each tip, which eliminates overbearing transaction charge issues for micro payments. Also with the transaction being delayed for a later date these pending tallies can be adjusted up or down, creating a certain impermanence which makes it safe to tip with-out filling in passwords or log-ins at each instance.

### SUBSTITUTE SPECIFICATION/NO NEW MATTER ADDED STATEMENT

This is a substitute of the specification originally filed on Oct. 20, 2009. This substitute specification contains no new matter.

### FIELD

The subject matter of the present application is in the field of online payments.

### BACKGROUND OF THE INVENTION

The internet presents material in a way that is akin to a plaza filled with street performers; what a website has is generally displayed for free and people are able to wander through and about them freely. This type of environment is suited for reciprocal payments, it is by tips that members of these environments get by. But whereas a street performer can deal in easy, simple cash, websites and browsers deal with tedious systems rife with transaction charges, which makes the situation untenable. It is known that humans have a higher rate of natural reciprocation than they have displayed online, and would likely be willing to tip if only the situational particulars were more reasonable. Websites may also embrace the concept as that it is difficult to get money in any other way in a street performer environment.

### SUMMARY OF INVENTION

The purpose of this invention is to supply an easier more efficient means for tipping. Since a tip relies on a voluntary action the tipper retains control over when to tip. This allows our software to keep a tally of intended tips and transact them all at once. This allows a 33 cent transaction fee that would normally be applied to each tip to be applied once to all tips, which eliminates the problem of the overbearing transaction fees for micro payments, and opens up the possibility of micro tipping. The second purpose is simplicity, which is created by our user plug-in and receiver programs. By using a tally that has not been transacted and will not be transacted for some time, and alluding to the fact that that tally can be adjusted down or up by an account holder even after a tip is made, it is safe to eliminate the sign ins and passwords normally necessary in an online transaction. This allows for single click tipping, via the toolbar provided with the browser plug-in, which eliminates the hassle that also inhibits low end tips.

Also inherent with tips, or voluntary payments, is the ease at which a giver can get cold feet or put off. In a sense they already have the product, so it is always easier to simply not pay. Only generosity and obligation can carry the tip through. Middlemen and tip obfuscation deter a persons sense of generosity. But in truth there are multiple deserving parties that will likely vie for a cut of tips, and we allow webhosts and such to set up their own divvy systems. To combat obfuscation our program also includes a clear and simple picture of the divvy. With one click a tipper can see what share of the tip the hosting site is taking, what the author takes, or perhaps 3^{rd} parties that provided research for the author, etc. . . . If a site receives many complaints of plagiarism, or attempting to profit off of other people's work, then their reputation is hurt. This is shown through a change in color of the status indication button.

A web browser shall sign up, create an account at our central site, and receive the plug-in. This plug-in inserts a toolbar onto the browser with pictures of coins. While browsing if a user, for instance, likes some particular article or content, they can click one of the coins which corresponds with its value. A message is sent to our central servers which notes the intention. One click on the status indication button and more information about the site and other options are available. A tally of these intentions is accumulated until a reasonable total in the range of $10 is reached, and a week before the transaction happens accounts with sufficient tips for transacting are sent an email informing them of the incoming charge. Once the money is charged it is sat on for a month for safety reasons. Then, baring any complaints, the money is then issued accordingly. Websites have their own downloaded program which helps manage information, divvies, and assign sites to the account. Both parties can login to their accounts at our central website which displays a variety of data pertinent to their account, as well as management options.

The final ingredient is the server based programs. As is typical, it is the servers which hold and manage accounts and facilitate their interactions. These programs do the actual tallying, and transacting and other financial interfaces. It is they that divvy and keep knowledge of the divvies, and supply a platform from which to supply this product.

These and other features and advantages of the invention will become apparent from the detailed description below, in light of the accompanying drawings.

### BRIEF DESCRIPTION OF THE DRAWINGS

FIG. 1 shows an example of what the toolbar will look like when active within a web browser.

FIG. 2 is an example of the divvy bar. Each color represents a party, the bar shows portion.

### DETAILED DESCRIPTION

The purpose of this invention is to supply an easier more efficient means for tipping. Since a tip relies on a voluntary action the tipper retains control over when to tip. This allows our software to keep a tally of intended tips and transact them all at once. This allows a 33 cent transaction fee that would normally be applied to each tip to be applied once to all tips, which eliminates the problem of the overbearing transaction fees for micro payments, and opens up the possibility of micro tipping. The second purpose is simplicity, which is created by our user plug-in and receiver programs. By using a tally that has not been transacted and will not be transacted for some time, and alluding to the fact that that tally can be adjusted down or up by an account holder even after a tip is made, it is safe to eliminate the sign ins and passwords normally necessary in an online transaction. This allows for single click tipping, via the toolbar provided with the browser plug-in, which eliminates the hassle that also inhibits low end tips.

Also inherent with tips, or voluntary payments, is the ease at which a giver can get cold feet or put off. In a sense they already have the product, so it is always easier to simply not pay. Only generosity and obligation can carry the tip through. Middlemen and tip obfuscation deter a person's sense of generosity. But in truth there are multiple deserving parties that will likely vie for a cut of tips, and we allow webhosts and such to set up their own divvy systems. To combat obfuscation our program also includes a clear and simple picture of the divvy. With one click a tipper can see what share of the tip the hosting site is taking, what the author takes, or perhaps 3^{rd} parties that provided research for the author, etc. . . . If a site receives many complaints of plagiarism, or attempting to profit off of other people's work, then their reputation is hurt. This is shown through a change in color of the status indication button.

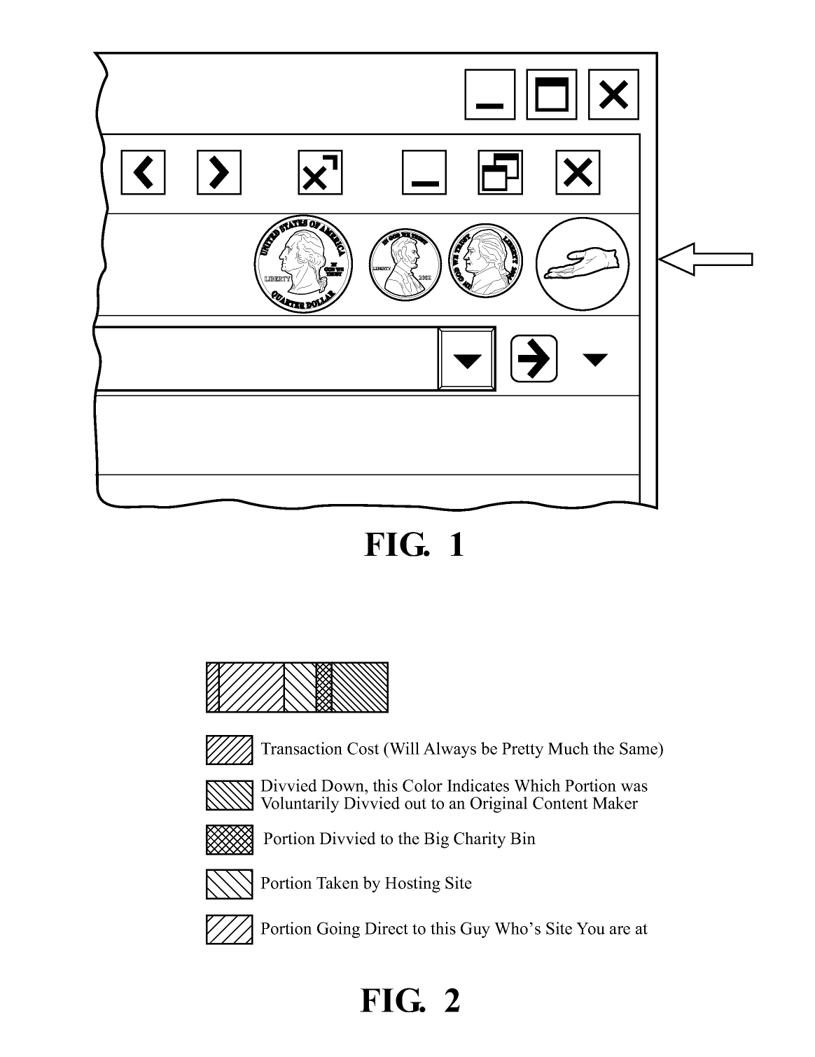

FIG. 1 shows an example of the toolbar when active within a web browser. A web browser shall sign up, create an account at our central site, and receive the plug-in. This plug-in inserts a toolbar onto the browser with pictures of coins. While browsing if a user, for instance, likes some particular article or content, they can click one of the coins which corresponds with its value. A message is sent to our central servers which notes the intention. One click on the status indication button and more information about the site and other options are available. A tally of these intentions is accumulated until a reasonable total in the range of $10 is reached, and a week before the transaction happens accounts with sufficient tips for transacting are sent an email informing them of the incoming charge. Once the money is charged it is sat on for a month for safety reasons. Then, barring any complaints, the money is then issued accordingly.

Websites have their own downloaded program which helps manage information, divvies, and assign sites to the account. Both parties can login to their accounts at our central website which displays a variety of data pertinent to their account, as well as management options.

FIG. 2 is an example of the divvy bar, each color represents a party, the bar shows portion. There are multiple deserving parties that will likely vie for a cut of tips, and we allow webhosts and such to set up their own divvy systems. To combat obfuscation our program also includes a clear and simple picture of the divvy. With one click a tipper can see what share of the tip the hosting site is taking, what the author takes, or perhaps 3^{rd} parties that provided research for the author, etc. . . . If a site receives many complaints of plagiarism, or attempting to profit off of other people's work, then their reputation is hurt. This is shown through a change in color of the status indication button.

Saloot at its core is a money transferring service designed specifically around online voluntary micro payments, aka donations, tips, and other forms of reciprocation. It allows a web browser give amounts as small as a penny towards content they appreciate. Inherent to a voluntary payment is a power by the giver to choose when to give. Saloot.com utilizes this fact to tally these tips rather than attempt transactions at the time of each tip, which eliminates overbearing transaction charge issues for micro payments. Also with the transaction being delayed for a later date these pending tallies can be adjusted up or down, creating a certain impermanence which makes it safe to tip with-out filling in passwords or log-ins at each instance. Saloot.com utilizes these facts to fulfill the needs of the tipping niche. Three main components are used to perform the function, which are being claimed within this patent: a plugin for web browsers to tip with, a program for websites to sign up and manage tip receiving websites, and web server based computer programs which coordinate the various elements and performs the computations, data storage, account management, and the actual transfer of funds.

This service and software is intended for international distribution, all aspects of the plug-in recited in claim 1, the program as recited in claim 2, and the central servers and databases as recited in claim 3, are subject to variations in language and appearance. Any reference to a ‘quarter’ or image of a quarter is expanded to include a ‘peso’ or other appropriate denomination from other countries and their corresponding value.

In the preceding description, various aspects and examples and configurations of making and using the invention as defined by the claimed subject matter have been described, for purposes of explanation, to provide a thorough understanding of claimed subject matter, and to enable those skilled in the art to make and use claimed subject matter. However, these are merely example illustrations and descriptions of inventive concepts wherein other illustrations may apply as well, and the scope of claimed subject matter is not limited in these respects. It should be apparent to one skilled in the art having the benefit of this disclosure that claimed subject matter may be practiced without being limited to the specific details of the disclosure. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of invention as reflected by the preceding disclosure. It should further be understood that to the extent the term “invention” is used in the written specification, it is not to be construed as a limiting term as to number or type of claimed or disclosed inventions or the scope of any such invention, and does not exclude discoveries or designs; rather, it is a term which has long been conveniently and widely used to describe new and useful improvements in technology.

What is claimed:

1. A computer-implemented program product, for use with a computer system web browser, comprising: one or more computer programs stored on a computer readable storage medium, which when executed by a processor causes the computer system to create a method for providing a donation/tip/reciprocation/voluntary payment online micro payment system utilizing a network browser toolbar/plug-in, comprising: three interchangeable ‘coin’ buttons which denote the appropriate value to be paid, status indicating button, and pop-up window when status button is clicked. See FIG. 1.

2. A computer-implemented program, for use with computer systems and web servers, comprising: one or more computer programs stored on a computer readable storage medium, which when executed by a processor creates a software interface to aid owners of receivership accounts (webhosts and content creator accounts) in managing the activities of their account. Variations include versions for singular accounts, and ‘meta accounts’ intended for web hosting sites.

3. A computer-implemented program, for use with a computer or web server computer systems, the implemented program product comprising: one or more computer programs stored on a computer readable storage medium, which when executed by a processor causes the computer systems to act as a component of a computer server network that works in conjunction with the toolbar/plug-in recited in claim 1 as well as website end receivership accounts recited in claim 2 to facilitate the tallying, transactions, divvying, encrypting, messaging, computations, storage, payments and other operations. Said program also manages the accounts of the ‘users’ (tippers using the plug-in recited in claim 1) and ‘receivers’ (site creator using program recited in claim 2)

4. A method as recited in claims 1, 2, and 3, wherein all messages between the plug-in and server programs are considered sensitive and are encrypted in all communications either from or too the server programs recited in claim 3, or from or too the browser plug-in program recited in claim 1, or from or too the website account program recited in claim 2, AND in storage of information as relating to the functions of the program recited in claim 3.

5. A method as recited in claim 3, wherein web browsers, websites/content creators, and webhosts can create user accounts, receiver accounts, and meta accounts respectively. Said accounts contain information such as name, email address, billing information, tip history information, other data, and Social Security numbers or business IDs for accounts receiving in excess of $600. This method also includes the storage of said information on digital mediums. This method also includes retrieval of information stored on database memory which relate to all accounts, such as pending cash flow, cash flow history, or payout history, URL list, divvy information, etc. . . . upon log-in by a users, and that information displayed.

6. A method as recited in claim 3, wherein a meta account holder has the ability to take a divvied portion of tips going to individuals posting on their site. Through login to this account they can access revenue data for everything under their umbrella of control or ownership, as well as adjust their divvy take for everything under their umbrella of control or ownership.

7. A method as recited in claim 3, wherein the program allows the user account owner to adjust data in relation to their account. In the case of receiver accounts these adjustments include method of receivership, personal or company information, email addresses, or charity bin preference. In the case of user accounts these adjustments include adjustments pending tips, personal information, billing information, and held tips recited in claim 15.

8. A method as recited in claim 1, wherein the plug-in queries the servers and programs recited in claim 3 to discern the status/reputation of the current site. Status/reputation is indicated by the color of the status button recited in claim 1. Colors are to represent the current site as follows: Green for good. Yellow for questionable. Red for poor. A graying of the button, while still appropriately colored, indicates that the current website is not signed up to receive tips/payments from our service.

9. A method as recited in claim 1, wherein the plug-in can utilize the local computer system to transmit the user's intended payments to our server based program network recited in claim 3. The transmitted message shall be encrypted and consist of: a user ID, the site ID, and the amount intended for payment, which may include ‘coin button’ click amounts or custom input amounts either positive or negative. The plug-in can also transmit adjustments made in the pop-up window.

10. The pop-up window as recited in claim 1 that opens upon clicking the status indication button consists of the following: (a) A user's pending total for this website. (b) A link to a user's personal account login portal. (c) A custom input bar where users can add OR subtract amounts from their pending total. (d) Various statistics about this website such as the average tip, and tip totals. (e) The divvy bar or divvy pie graph. (f) A text description of what parties are represented in the divvy bar or divvy pie graph. (g) A button to lock the plug-in from transmitting more tip intentions until a password is entered. (h) A small input bar for typing in one's password. (i) A line of the available coins which can be interchanged with those in the tool bar tray with the current three highlighted. (j) Three customizable coins shall accompany the available coins who's picture and value can be altered at will. (k) A ‘flag’ button for users to indicate any sense of fowl-play, such as plagiarism, on behalf of the website.

11. A method as recited in claim 10, wherein the plug-in queries our servers for the appropriate information to fill in the pop-up window upon clicking the status indication button. Information is to include divvy bar statistics, site statistics, user's pending total.

12. A divvy bar or pie graph as recited in claim 10 shall display how intended tips shall be split via splits in percentage, totaling 100%. Each color represents a different potential receiver, including: The transactors (ourselves, credit card companies, online banking companies). The single author or creator or webhost responsible for the website's content. A company creator of the content before you. A third party creator or attributer to the content before you. A hosting site which is hosting the material before you but not of direct responsibility for its content. The charity bin. Taxes. Examples of its general appearance are given in FIG. 2.

13. A method as recited in claim 2, wherein the program allows site managers to add and subtract URLs/sites within their control troll to their account, thus allowing those websites to receive tips. Said program also allows site mangers to individually adjust the divvy portions allocated to each URL/site within their account.

14. A method as recited in claim 2, wherein the program transmits data, such as the addition of URLs/sites or adjustments in the divvy bar or adjustments to various options, to the programs recited in claim 3.

15. A method as recited in claim 3, wherein the central database and programs take the following actions with regards to incoming tips. Tallies of tips are formed from each user intended for each site/receiver as dictated by the data sent from the plug-in recited in claim 1. At the monthly billing date account holders with tallies above the designate minimum are sent an email informing them of the intended charge. A week later the user accounts are charged for their tallies, and inflowing money is accumulated into a single account and held for one month for safety purposes. This money is referred to as ‘held tips’. After the holding month the divvy for each tip is properly assigned and computed for each tip. A divvy can split tips between various receivers as recited in claim 12. The funds are then sent to their corresponding receivership accounts in accordance with the preferences stated by the receiver.

16. A method as recited in claim 3, wherein user accounts tip history also provides links to the website tipped. All pending for each place are adjustable plus or minus, held tips are also shown and can be reduced but not added to.

17. A method as recited in claim 3, wherein upon login a user has the ability to lodge a complaint to inform of incorrect totals or plagiaristic websites or other issue of complaint.

18. A method as recited in claim 3, wherein site accounts and meta accounts are assigned a corresponding ID tag to be inserted into their website HTML. It is this ID tag which is recognized by the plug-in and designates a site which can be actively tipped. This ID is also transmitted with the information package recited in claim 9.

19. A method as recited in claim 3, wherein websites that are not signed up with our service, yet are receiving pending tips (such tips are not transacted and remain pending until the website signs up) totaling more than $10 shall be sent an email to the email address provided in their web registration form informing them of their pending tips.
